(19) United States
(12) Patent Application Publication
(10) Pub. No.: US 2021/0308557 A1
(43) Pub. Date: Oct. 7, 2021

(54) SLEEVE SYSTEMS FOR PROTECTING A TRADING CARD

(71) Applicant: Dante Baldocchi, Altadena, CA (US)

(72) Inventor: Dante Baldocchi, Altadena, CA (US)

(21) Appl. No.: 17/348,597

(22) Filed: Jun. 15, 2021

(51) Int. Cl. A63F 1/10

(52) U.S. Cl. CPC A63F 1/10

(57) ABSTRACT

Sleeve systems including a sleeve and a tab. The sleeve systems function to protect a trading card. The sleeve is complementarily configured with the trading card to receive the trading card. The tab is coupled to the sleeve. In some examples, the sleeve system includes a shell complementarily configured with the sleeve to receive the sleeve.

### BACKGROUND

The present disclosure relates generally to sleeve systems. In particular, sleeve systems for protecting a trading card are described.

Trading cards, also known as collectable cards or gaming cards, are popular with fans of sports, gaming, and other subjects. Trading cards are usually made from paperboard or thick paper. Trading cards often contain an image of a certain fictional or real person, place, or thing and a short description of the picture, along with other text.

There are many different types of trading, cards. Trading cards are traditionally associated with sports with baseball cards being especially well-known. Trading cards dealing with other subjects like Pokémon are often considered a separate category from sports-focused trading cards and are known as non-sports trading cards. Non-sports trading cards often feature cartoons, comic book characters, and television series or film stills.

Cards designed specifically for playing games have become popular enough to develop into a distinct category: collectible game cards. Collectable game cards often feature fantasy-based gameplay. Fantasy in are a subgenre of trading cards that focus on the artwork.

Trading cards may be admired, traded, or sold. For a given trading card depicting a given person or subject, e.g., a Mickey Mantle baseball card, the value of the trading cards is often tied to the condition of the trading card. Trading cards that are closer to “mint” condition will be worth more than the same cards would be if damaged or degraded in some way.

Various products exist to protect trading cards to help preserve their value and appeal. Hard shell cases, plastic sheets, and card sleeves are examples of some of the products currently existing to protect trading cards. A card sleeve (hereinafter simply, sleeve,) is a convenient and cost effective way to protect a single trading card. Sleeves are generally relatively soft and pliable and stored within rigid outer shells for more robust protection.

Existing sleeves are not entirely satisfactory, however. For example, existing sleeves are difficult to retrieve from rigid outer shells once inserted into the shells. It would be desirable for sleeves to be more easily inserted into and retrieved from shells than is currently possible.

Another shortcoming of existing sleeves is that they are not well suited to organizing trading cards. Conventional sleeves tend to consist of a clear plastic body that closely conforms to the size and shape of the trading card. With conventional sleeves, there are no features to help organize a collection of sleeves containing different trading cards. Adding a label onto a conventional sleeve or marking it to assist with organizing would undesirably obscure the trading card contained within it.

Thus, there exists a need for solutions that improve upon and advance the design of known sleeves and that provide an effective system of sleeves and outer shells. Examples of new and useful sleeve systems relevant to the needs existing in the field are discussed below.

### SUMMARY

The present disclosure is directed to sleeve systems including a sleeve and a tab. The sleeve systems function to protect a trading card. The sleeve is complementarily configured with the trading card to receive the trading card. The tab is coupled to the sleeve. In some examples, the sleeve system includes a shell complementarily configured with the sleeve to receive the sleeve.

### BRIEF DESCRIPTION OF THE DRAWINGS

FIG. 1 is a perspective view of a sleeve system protecting a trading card with a user starting to pull a sleeve out of a shell by grasping a tab with his fingers.

FIG. 2 is a front elevation view of the sleeve system shown in FIG. 1.

FIG. 3 is a front elevation view of the sleeve shown in FIG. 1.

FIG. 4 is a front elevation view of an alternative sleeve with a colored tab.

### DETAILED DESCRIPTION

The disclosed sleeve systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various sleeve systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Sleeve Systems For Protecting a Trading Card

With reference to the figures, sleeve systems for protecting a trading card will now be described. The sleeve systems discussed herein function to protect and display trading cards. In certain examples, the sleeve systems described below facilitate organizing trading cards protected by the sleeve systems.

The reader will appreciate from the figures and description below that the presently disclosed sleeve systems address many of the shortcomings of conventional sleeve systems. For example, the sleeves described herein are easy to retrieve from rigid outer shells once inserted into the shells. The sleeves are also more easily positioned within the shells than is currently possible.

Another improvement over existing sleeves is that the sleeve systems described below are well suited to organizing trading cards. The sleeve systems described herein include features to help organize a collection of sleeves containing different trading cards without undesirably obscuring the trading card contained within the sleeves.

Contextual Details

Ancillary features relevant to the sleeve systems described herein will first be described to provide context and to aid the discussion of the sleeve systems.

Trading Card

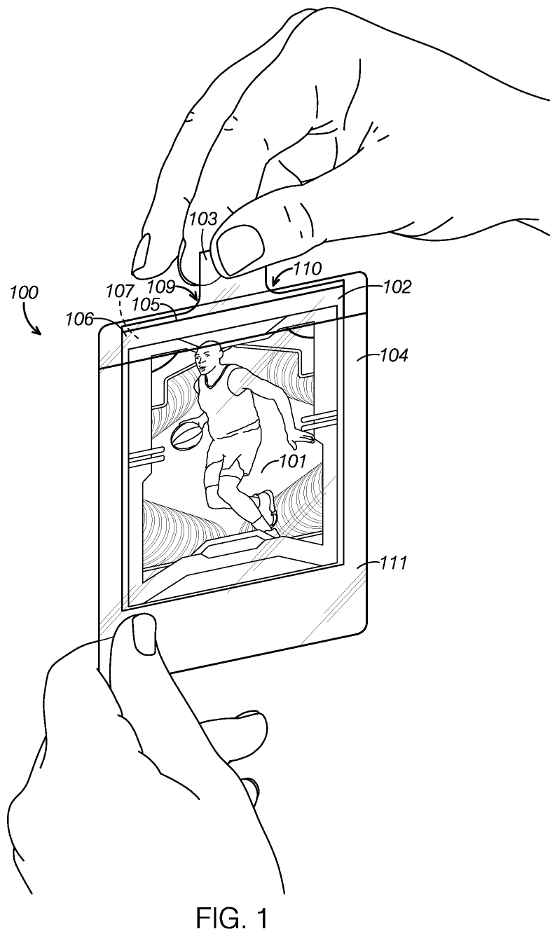

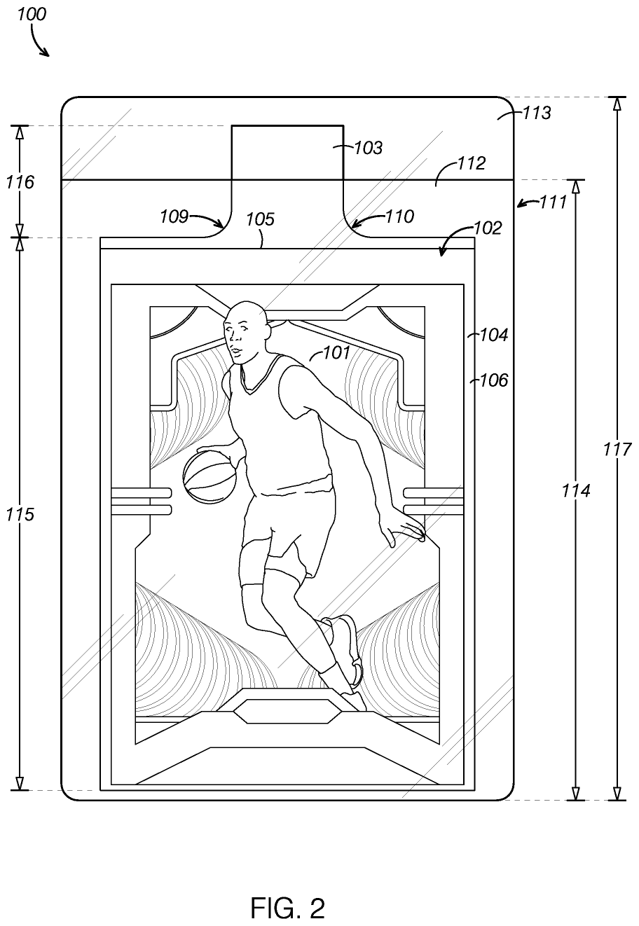

Trading cards (also known as collectable cards) are protected by the sleeve systems described in this document. In the example shown in FIGS. 1 and 2, a trading card 101 is a basketball card. However, the trading card may be cards for other sports, such as baseball cards, hockey cards, soccer cards, and the like. Alternatively to a sports-focused trading card, the trading card may be a non-sports trading card, or a collectable game card. The trading card may be any currently known or later developed type of trading card.

The size and shape of the trading card may be different than depicted in FIGS. 1 and 2. In some examples, the trading card is larger relative to the other components than depicted in the figures. In other examples, the trading card is smaller relative to the other components than depicted in the figures. Further, the reader should understand that the trading card and the other components may all be larger or smaller than described herein while maintaining their relative proportions.

Sleeve System Embodiment One

With reference to FIGS. 1-3, a sleeve system 100 will now be described as a first example of a sleeve system. As shown in FIGS. 1-3, sleeve system 100 includes a sleeve 102, a tab 103, and a shell 111. In other examples, the sleeve system includes fewer components than depicted in the figures, such as not including a shell. In certain examples, the sleeve system includes additional or alternative components than depicted in the figures.

The shape of the sleeve system may be adapted to be different than the specific examples shown in the figures to suit a given application. For example, the sleeve system may include a face having the shape of a regular or irregular polygon, such as a circle, oval, triangle, square, rectangle pentagon, and the like. Additionally or alternatively, the sleeve system nay include a face having an irregular shape. The shape of the sleeve may be selected to match the shape of a given trading card, which may not be rectangular like trading card 101.

The size of the sleeve system may be varied as needed for a given application or trading card to be inserted into the sleeve. In some examples, the sleeve system is larger relative, to the other components than depicted in the figures. In other examples, the sleeve system is smaller relative to the other components than depicted in the figures. Further, the reader should understand that the sleeve system and the other components may all be larger or smaller than described herein while maintaining their relative proportions.

Sleeve

The reader can see in FIGS. 1 and 2 that sleeve 102 functions to protect trading card 101. As depicted in FIGS. 1 and 2, sleeve 102 is complementarily configured with trading card 101 to receive trading card 101 and to closely conform to the dimensions of trading card 101. With reference to FIGS. 1-3, sleeve 102 includes a body 104.

As shown in FIGS. 1 and 2, sleeve 102 is transparent. In the example shown in FIGS. 1-3, sleeve 102 is comprised of plastic and is flexible. As shown in FIG. 2, sleeve 102 defines sleeve length 115 and defines a sleeve opening 105 through which trading card 101 may be inserted.

Body 104 functions to surround and protect trading card 101. Further, body is transparent to allow trading card 101 to be seen through body 104.

The reader can see in FIGS. 1 and 2 that body 104 defines opening 105 through which trading card 101 inserts into sleeve 102. As depicted in FIGS. 1-3, body 104 includes a front face 106 and a rear face 107. With reference to FIGS. 1-3, rear face 107 is opposite front face 106.

The shape of the sleeve may be adapted to be different than the specific examples shown in the figures to suit a given application. For example, the sleeve may include a face having the shape of a regular or irregular polygon, such as a circle, oval, triangle, square, rectangle pentagon, and the like. Additionally or alternatively, the sleeve may include a face having an irregular shape. The shape of the sleeve may be selected to match the shape of a given trading card, which may not be rectangular like trading card 101.

The size of the sleeve may be varied as needed for a given application or trading card to be inserted into the sleeve. In some examples, the sleeve is larger relative to the other components than depicted in the figures. In other examples, the sleeve is smaller relative to the other components than depicted in the figures. Further, the reader should understand that the sleeve and the other components may all be larger or smaller than described herein while maintaining their relative proportions.

In the present example, the sleeve is composed of clear plastic. However, the sleeve may be composed of any currently known or later developed material suitable for the applications described herein for which it is used.

Tab

Tab 103 functions to facilitate retrieving sleeve 102 from shell 111 and generally facilitates moving sleeve 102 without touching and potentially smudging body 104. As depicted in FIG. 2, tab 103 defines tab length 116. The reader can see in FIG. 1 that tab 103 is sized to be grasped by fingertips of a user.

As depicted in FIGS. 1-3, tab 103 is coupled to sleeve 102. In the present example, as depicted in FIGS. 1-3, tab 103 is integrally coupled to sleeve 102. With reference to FIGS. 1-3, tab 103 is coupled to rear face 107 of body 104 proximate opening 105.

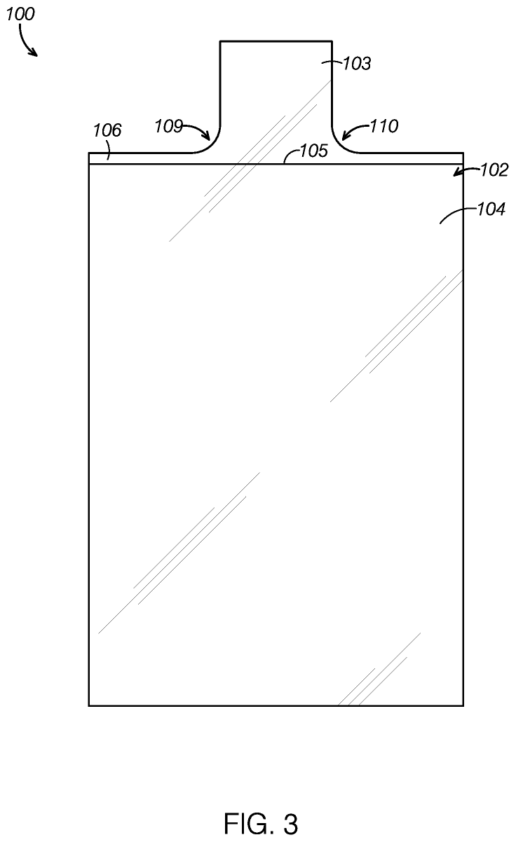

With reference to FIGS. 2 and 3, tab 103 and sleeve 102 cooperatively define a first transition region 109 and a second transition region 110 where tab 103 integrally couples to sleeve 102. As shown in FIGS. 2 and 3, second transition region 110 is opposite first transition region 109. With reference to FIGS. 2 and 3, first transition region 109 and second transition region 110 are curved.

The shape of the transition regions may be adapted to be different than the specific examples shown in the figures to suit a given application. For example, one or more of the transition regions may be curved differently than shown in the figures, be an angled straight edge, be a series of multiple angled straight edges, be rectilinear, or be an irregular shape.

The reader can see in FIG. 2 that tab 103 extends beyond a first shell face 112 when sleeve 102 is received in shell 111. Tab 103 extending beyond first shell face 112 facilitates a user grasping tab 103 to remove sleeve 102 from shell 111.

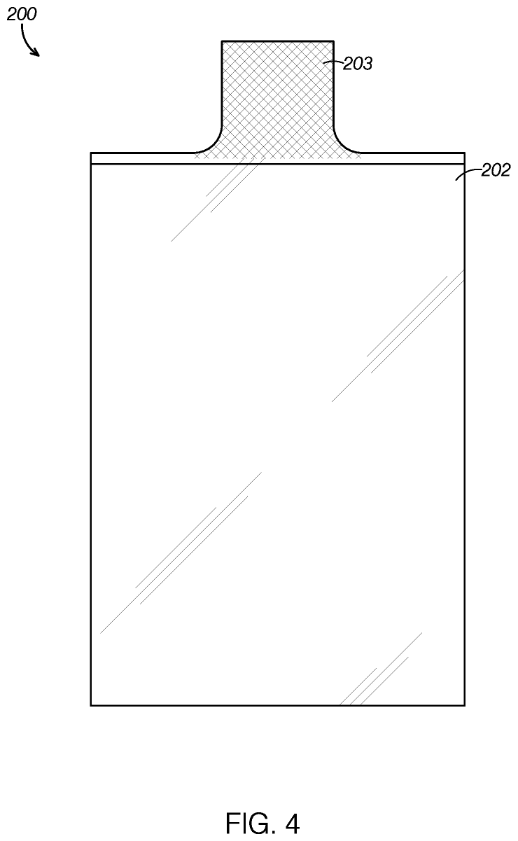

In sleeve system 100 depicted in FIGS. 1-3, tab 103 is clear. In other examples, such as a tab 203 depicted in FIG. 4, the tab may be colored or patterned. In some examples, the tab includes indicia or symbols.

The number of tabs in the sleeve system may be selected to meet the needs of a given application. The reader should appreciate that the number of tabs may be different in other examples than is shown in the figures. For instance, some sleeve system examples include additional or fewer tabs than described in the present example.

The share of the tab may be adapted to be different than the specific examples shown in the figures to suit a given application. For example, the tab may include a face having the shape of a regular or irregular polygon, such as a circle, oval, triangle, square, rectangle pentagon, and the like. Additionally or alternatively, the tab may include a face having an irregular shape. In three dimensions, the shape of the tab may be a sphere, a pyramid, a cone, a cube, and variations thereof, such as a hemisphere or a frustoconical shape.

The size of the tab may be varied as needed for a given application. In some examples, the tab is larger relative to the other components than depicted in the figures. In other examples, the tab is smaller relative to the other components than depicted in the figures. Further, the reader should understand that the tab and the other components may all be larger or smaller than described herein while maintaining their relative proportions.

Shell

The role of shell 111 is to receive and protect sleeve 102 containing trading card 101. Shell 111 also functions to enable sleeve 102 and trading card 101 to be seen when inserted in shell 111. In the example shown in FIGS. 1-3, shell 111 is rigid and transparent.

The reader can see in FIGS. 1 and 2 that shell 111 includes a first shell face 112 and a second shell face 113. As depicted in FIGS. 1 and 2, second shell face 113 is opposite first shell face 112. With reference to FIG. 2, first shell face 112 defines first shell face length 114 and second shell face 113 defines second shell face length 117.

As depicted in FIGS. 1 and 2, shell 111 is complementarily configured with sleeve 102 to receive sleeve 102. With reference to FIGS. 1 and 2, shell 111 receives sleeve 102 between first shell face 112 and second shell face 113.

The shape of the shell may be adapted to be different than the specific examples shown in the figures to suit a given application. For example, the shell may include a face having the shape of a regular or irregular polygon, such as a circle, oval, triangle, square, rectangle pentagon, and the like. Additionally or alternatively, the shell may include a face having an irregular shape. In three dimensions, the shape of the shell may be a sphere, a pyramid, a cone, a cube, and variations thereof, such as a hemisphere or a frustoconical shape.

The size of the shell may be varied as needed for a given application or a given trading card size. In some examples, the shell is larger relative to the other components than depicted in the figures. in other examples, the shell is smaller relative to the other components than depicted in the figures. Further, the reader should understand that the shell and the other components may all be larger or smaller than descried herein while maintaining their relative proportions.

In the present example, the shell is composed of a clear, rigid plastic. However, the shell may be composed of any currently known or later developed material suitable for protecting a sleeve containing a trading card. Suitable materials include metals, polymers, ceramics, wood, and composite materials.

Relative Dimensions of the Sleeve, Tab, and Shell

The relative dimensions of sleeve 102, tab 103, and shell 111 are selected to facilitate sleeve fully containing trading card 101, sleeve 102 inserting into shell 111, and tab 103 being easily accessible when sleeve 102 is in shell 111. To facilitate tab 103 being easily accessible when sleeve 102 is in shell 111, as shown in FIG. 2, the sum of sleeve length 115 plus tab length 116 is greater than first shell lace length 114.

To protect tab 103 from one side, the reader can see in FIG. 2 that second shell face length 117 is greater than first shell face length 114. Further, the sum of sleeve length 115 plus tab length 116 is less than second shell face length 117 such that second shell face extends beyond tab 103 when sleeve 102 is inserted into shell 111.

In other examples, the relative dimensions of the sleeve, the tab, and the shell are different than the specific example shown in FIGS. 1-3. Any relative dimensions suitable for a given objective may be selected.

Additional Embodiments

With reference to the figures not yet discussed in detail, the discussion now focus on additional sleeve system embodiments. The additional embodiments include many similar or identical features to sleeve system 100. Thus, for the sake of brevity each feature of the additional embodiments below will not be redundantly explained. Rather, key distinctions between the additional embodiments and sleeve system 100 will be described in detail and the reader should reference the discussion above for features substantially similar between the different sleeve system examples.

Sleeve System Embodiment Two

Turning attention to FIG. 4, a sleeve system 200 will low be described as a second example of a sleeve system. As can be seen in FIG. 4, sleeve system 200 includes a sleeve 202 and a tab 203. In other examples, the sleeve system includes fewer components than depicted in the figures. In certain examples, the sleeve system includes additional or alternative components than depicted in the figures, such as including a shell.

The primary distinction between system 100 and system 200 is that tab 20 is colored as depicted in FIG. 4 whereas tab 103 is clear. Tab 203 being colored facilitates organizing sleeves. For example, trading cards from a given year may be stored in sleeves with a red tab and sleeves from a different year may be stored in sleeves with a blue tab.

The color or pattern of the tab may be any desired color or pattern. In some examples, the tabs have indicia or symbols on them in addition or alternatively to being colored or patterned.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A sleeve system for protecting a trading card, the sleeve system comprising:
a sleeve complementarily configured with the trading card to receive the trading card; and
a tab coupled to the sleeve.

2. The sleeve system of claim 1, wherein:
the sleeve includes a body;
the body defines an opening through which the trading card inserts into the sleeve; and
the tab is coupled to the body proximate the opening.

3. The sleeve system of claim 2, wherein:
the body includes:
a front face; and
a rear face opposite the front face; and
the tab is coupled to the rear face.

4. The sleeve system of claim 1, wherein the tab is sized to be grasped by fingertips of a user.

5. The sleeve system of claim 1, wherein the tab is integrally coupled to the sleeve.

6. The sleeve system of claim 5, wherein the tab and the sleeve cooperatively define a first transition region where the tab integrally couples to the sleeve.

7. The sleeve system of claim 6, wherein the first transition region is curved.

8. The sleeve system of claim 7, wherein:
the tab and the sleeve cooperatively define a second transition region where the tab integrally couples to the sleeve;
the second transition region is opposite the first transition region; and
the second transition region is curved.

9. The sleeve system of claim 1, wherein the sleeve is transparent.

10. The sleeve system of claim 9, wherein the tab is colored

11. The sleeve system of claim 9, wherein the sleeve is comprised of plastic.

12. The sleeve system of claim 11, wherein the sleeve is flexible.

13. The sleeve system of claim 1, further comprising a shell complementarily configured with the sleeve to receive the sleeve.

14. The sleeve system of claim 13, wherein the shell is rigid.

15. The sleeve system of claim 14, wherein the shell is transparent.

16. The sleeve system of claim 13, wherein:
the shell includes:
a first shell face; and
a second shell face opposite the first shell face; and
the sleeve is received by the shell between the first shell face and the second shell face.

17. The sleeve system of claim 16, wherein the tab extends beyond the first shell face when the sleeve is received in the shell.

18. The sleeve system of claim 17, wherein:
the first shell face defines a first shell face length;
the sleeve defines a sleeve length;
the tab defines a tab length; and
the sleeve length plus the tab length is greater than the first shell face length.

19. The sleeve system of claim 18, wherein:
the second shell face defines a second shell face length; and
the second shell face length is greater than the first shell face length.

20. The sleeve system of claim 19, wherein the sleeve length plus the tab length is less than the second shell face length.
